(19) United States
(12) Patent Application Publication
(10) Pub. No.: US 2026/0067522 A1
(43) Pub. Date: Mar. 5, 2026

(54) Instant Subscribe System for Connected TV Platforms

(71) Applicant: Laura Linza, Roseville, CA (US)

(72) Inventor: Laura Linza, Roseville, CA (US)

(21) Appl. No.: 19/349,938

(22) Filed: Oct. 3, 2025

Related U.S. Application Data
(60) Provisional application No. 63/873,876, filed on Sep. 1, 2025.

(51) Int. Cl. H04N 21/422; H04N 21/41; H04N 21/431; H04N 21/45; H04N 21/472

(52) U.S. Cl. CPC H04N 21/4221; H04N 21/4126; H04N 21/4312; H04N 21/4532; H04N 21/472

(57) ABSTRACT

Systems are disclosed for enabling instant subscription to streaming content channels. A remote control includes a dedicated subscription button configured to transmit a subscription action to a display device. A display device presents streaming content with a machine-readable code overlay enabling subscription via a companion device. A companion application provides a one-tap subscription control linked to a viewer account. Each embodiment allows a user to subscribe without navigating menus or interrupting playback, thereby reducing friction and increasing channel subscriptions.

### BACKGROUND OF THE INVENTION

Viewers increasingly consume video content through connected television platforms such as Apple TV®, Roku® devices, Amazon Fire TV Stick®, and smart TVs. While these platforms provide access to streaming services and creator-driven channels, subscribing to such channels directly from a television interface remains cumbersome. Current subscription methods typically require users to navigate multiple on-screen menus, enter account credentials through on-screen keyboards, or leave playback entirely to complete the process. These steps create friction, discourage subscription actions, and diminish overall viewer engagement.

This challenge impacts both viewers and content creators. For viewers, the inability to subscribe quickly and seamlessly results in frustration and reduced interaction with preferred channels. For content creators and platforms, the lack of an intuitive subscription pathway leads to lower subscriber conversion rates, diminished recurring revenue opportunities, and lost potential for monetization. While some platforms have experimented with companion mobile apps or account pairing, these solutions still require multiple steps, rely on prior device setup, or interrupt the viewing experience, leaving the problem unresolved.

Accordingly, there is a need for systems that enable instant subscription actions directly from the viewing context on connected televisions. Such systems would reduce barriers for viewers, increase subscription rates for creators, and enhance monetization opportunities for streaming platforms.

### SUMMARY OF THE INVENTION

The present invention provides systems for enabling instant subscription to streaming channels while minimizing disruption to the viewing experience. In various embodiments, the invention allows a viewer to subscribe to a channel without navigating menus, typing on an on-screen keyboard, or leaving playback.

In one embodiment, an input device such as a remote control includes a dedicated subscription control that, when activated, transmits a subscription command to a display device currently presenting streaming content. In another embodiment, a display device generates and overlays a machine-readable code, such as a QR code, that can be scanned by a companion device to complete a subscription action associated with the channel being displayed. In yet another embodiment, a companion device executes a software application configured with a one-tap subscription control that links a viewer account to the channel being presented.

These embodiments may operate independently or in combination, providing viewers with seamless, low-friction methods to subscribe to content. By reducing barriers to subscription, the invention increases subscriber conversion rates, improves engagement for content creators, and enhances monetization opportunities for streaming platforms.

### BRIEF DESCRIPTION OF THE DRAWINGS

FIG. 1 is a perspective view of a remote control (100) comprising navigation buttons (110), standard control buttons (120), a dedicated subscription button (130), and a transmitter (140).

FIG. 2 is a diagrammatic view of a display device (200) presenting streaming content (210) with a machine-readable code overlay (220), the code generated by a processor (230).

FIG. 3 is a schematic view of a companion device (300) executing a software application, the application presenting a user interface (310) with a one-tap subscription control (320), and including a processor (330) configured to transmit subscription actions.

### DETAILED DESCRIPTION OF THE INVENTION

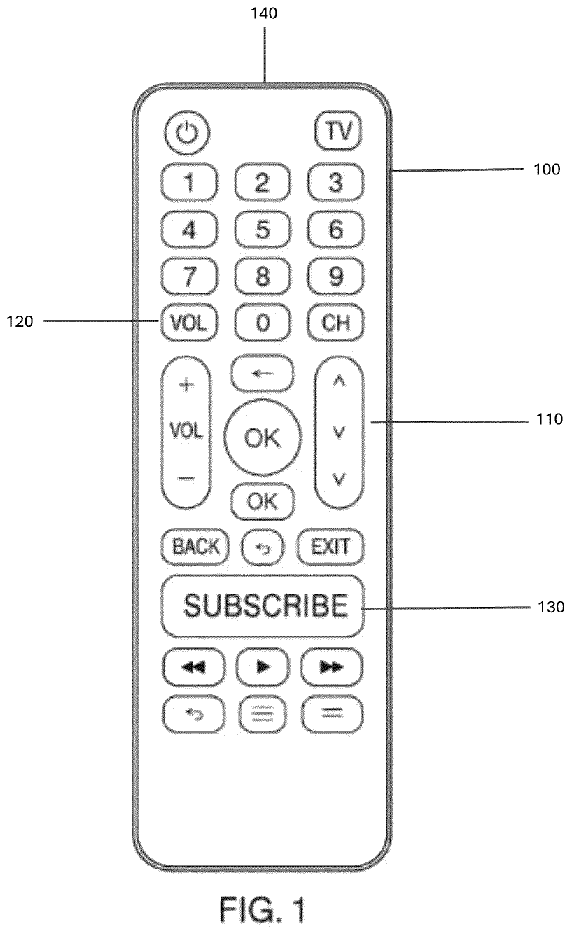

FIG. 1 illustrates a remote control (100) including navigation buttons (110), standard control buttons (120), and a dedicated subscription button (130). A transmitter (140), such as an infrared emitter or Bluetooth® transceiver, is disposed at the top of the remote control (100) and is configured to communicate subscription commands to a display device.

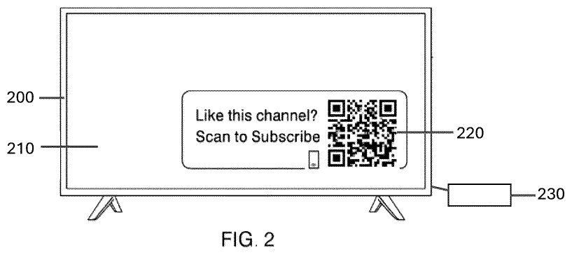

FIG. 2 illustrates a display device (200) presenting streaming content (210). The display device (200) generates and renders a machine-readable code (220), such as a QR code overlay, via a processor (230). When scanned by a companion device, the machine-readable code (220) enables instant subscription.

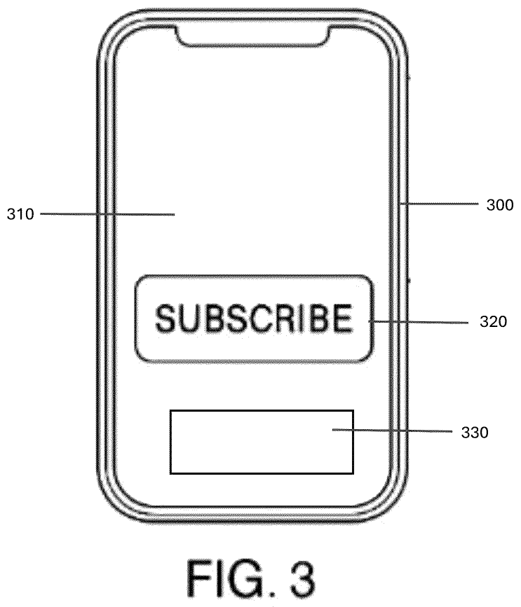

FIG. 3 illustrates a companion device (300) executing a software application. The user interface (310) includes a one-tap subscription control (320) for activation by the user. A processor (330) within the device transmits subscription actions to associate the viewer account with the displayed channel.

1. A system comprising:
a remote control (110) including a dedicated subscription button (120); and
a transmitter (140) configured to communicate with a display device (200) presenting streaming content.

2. The system of claim 1, wherein the subscription button (120) is labeled “Subscribe.”

3. The system of claim 1, wherein activation of the subscription button (120) transmits a command to initiate a subscription action associated with the channel being presented.

4. The system of claim 1, wherein the transmitter (140) communicates wirelessly with the display device (200).

5. The system of claim 1, wherein the subscription command is configured to link to a viewer account stored on the display device (200).

6. A system comprising:
a display device (200) configured to overlay a machine-readable code (220) onto streaming content;
wherein the machine-readable code (220) encodes subscription information associated with a channel being presented.

7. The system of claim 6, wherein the machine-readable code (220) comprises a QR code.

8. The system of claim 6, wherein the machine-readable code (220) encodes a time-limited token associated with the channel subscription.

9. The system of claim 6, wherein the machine-readable code (220) is dynamically generated during playback of the channel.

10. The system of claim 6, wherein the machine-readable code (220) includes metadata specifying a creator identifier.

11. The system of claim 6, wherein scanning the machine-readable code (220) by a companion device (300) triggers a subscription confirmation.

12. The system of claim 6, wherein the display device (200) is further configured to communicate with a subscription management server via an application programming interface (API).

13. A system comprising:
a companion application (310) executing on a mobile device (300);
the companion application (310) including a subscription interface (320) configured to link a viewer account to a channel being presented on a display device (200).

14. The system of claim 13, wherein the subscription interface (320) comprises a one-tap control for completing a subscription action.

15. The system of claim 13, wherein the companion application (310) communicates via a processor (330) with the display device (200) to confirm the subscription action.
